(19) United States
(12) Patent Application Publication
(10) Pub. No.: US 2025/0119028 A1
(43) Pub. Date: Apr. 10, 2025

(54) TACHOMETER ASSEMBLY FOR A MOTOR-MOUNTED BRAKE, MOTOR-MOUNTED BRAKE AND DRIVE ASSEMBLY

(71) Applicant: DELLNER BUBENZER Germany GmbH, Kirchen-Wehbach (DE)

(72) Inventor: Jan-Willem SCHONEVELD, Katwijk (NL)

(73) Assignee: DELLNER BUBENZER Germany GmbH, Kirchen-Wehbach (DE)

(21) Appl. No.: 18/982,725

(22) Filed: Dec. 16, 2024

Related U.S. Application Data
(63) Continuation of application No. PCT/EP2023/065846, filed on Jun. 13, 2023.

(30) Foreign Application Priority Data
Jun. 14, 2022 (DE) 20 2022 103 346.3

(51) Int. Cl. H02K 11/21; H02K 7/10; H02K 11/00

(52) U.S. Cl. CPC H02K 11/21; H02K 7/10; H02K 11/0094

(57) ABSTRACT

A tachometer assembly for a motor-mounted brake comprising a stator component which, in operation, can be coupled to a housing component of the motor-mounted brake. A rotor component can be coupled to a drive shaft passing through the motor-mounted brake. The stator component comprises a stator body which has a base flange and a connecting flange. The base flange has a housing-side centering collar on its outer circumference. The connecting flange adjoins the base flange in an axially offset manner and forms an inner wall on its inner circumference, which together with an outer surface of the base flange forms a receiving space for the rotor component. The receiving space is closed off from the outside environment by a cover which can be fixed to the connecting flange.

This nonprovisional application is a continuation of International Application No. PCT/EP2023/065846, which was filed on Jun. 13, 2023, and which claims priority to German Patent Application No. 20 2022 103 346.3, which was filed in Germany on Jun. 14, 2022, and which are both herein incorporated by reference.

### BACKGROUND OF THE INVENTION

### Field of the Invention

The present disclosure relates generally and particularly to tachometer assemblies for a motor-mounted brake and to a motor-mounted brake and a drive assembly.

### Description of the Background Art

Tachometers which can be attached to motor-mounted brakes are generally known. These tachometers permit a rapid and simple braking of externally and internally ventilated motors, such as can be found, for example, in trolleys, trolley chassis and hoisting gears on crane systems.

The particularly compact motor-mounted brakes are used, in particular, in harsh environmental conditions, since the functional elements of the actual brake can be effectively shielded against environmental influences by a covering.

Due to their compact design, the motor-mounted brakes are also suitable for use in particularly space-restricted installation situations.

Tachometer assemblies (tachometers or speed measuring devices) serve for monitoring operating criteria of the drives controlled by means of the motor-mounted brake and the motor-mounted brake itself.

FIG. 3 shows a tachometer assembly according to the conventional art. The actual tachometer 100 is connected in this case via an adapter assembly 110 to a housing component 120 of the actual motor-mounted brake 140. Inside, the coupling takes place via a driver assembly which is coupled to the tachometer shaft within the adapter assembly 110. In this manner, a secure coupling of the tachometer 100 to the drive 150 of the motor-mounted brake 140 is ensured, but the tachometer assembly or the tachometer 100 itself protrudes significantly out of the actual motor-mounted brake 140 and a plurality of both external and internal adapter components are required in order to couple the tachometer 100 to the drive 150 of the motor-mounted brake 140. Thus an assembly is complex to mount, it requires a relatively large amount of installation space and has to be centered and oriented in a complex manner to the fixed and movable active elements of the motor-mounted brake 140.

Typical tachometers are connected by an input shaft to the housing component of the motor-mounted brake. To this end, the input shaft has fastening devices on its end facing away from the base plate and the electric motor, a further shaft, such as for example a motor shaft which extends through an opening, being able to be fastened thereto.

The majority of tachometers are actually speedometers in terms of measuring principle. However, optical or capacitive sensors can be unreliable in harsh conditions, in particular in the case of condensation or dust.

### SUMMARY OF THE INVENTION

It is therefore an object of the invention to provide an improved tachometer assembly for a motor-mounted brake.

According to an example, the present disclosure provides a tachometer assembly for a motor-mounted brake. This tachometer assembly comprises a stator component which, in operation, can be coupled to a housing component of the motor-mounted brake, a rotor component which can be coupled to a motor shaft passing through the motor-mounted brake, wherein the stator component comprises a stator body which has a base flange and a connecting flange, the base flange has a housing-side centering collar on its outer circumference, the connecting flange adjoins the base flange in an axially offset manner and forms an inner wall on its inner circumference, which together with an outer surface of the base flange forms a receiving space for the rotor component, and the receiving space is closed off from the outside environment by a cover which can be fixed to the connecting flange.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view from outside of a motor-mounted brake on a drive with a tachometer assembly according to the invention;

FIG. 2 shows a longitudinal sectional view of the assembly shown in FIG. 1; and

FIG. 3 shows a perspective view of a motor-mounted brake for a conventional tachometer assembly.

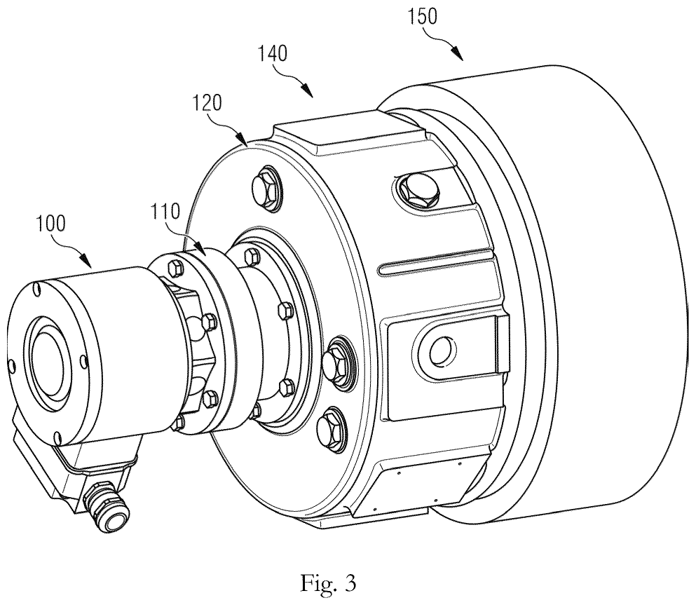

### DETAILED DESCRIPTION

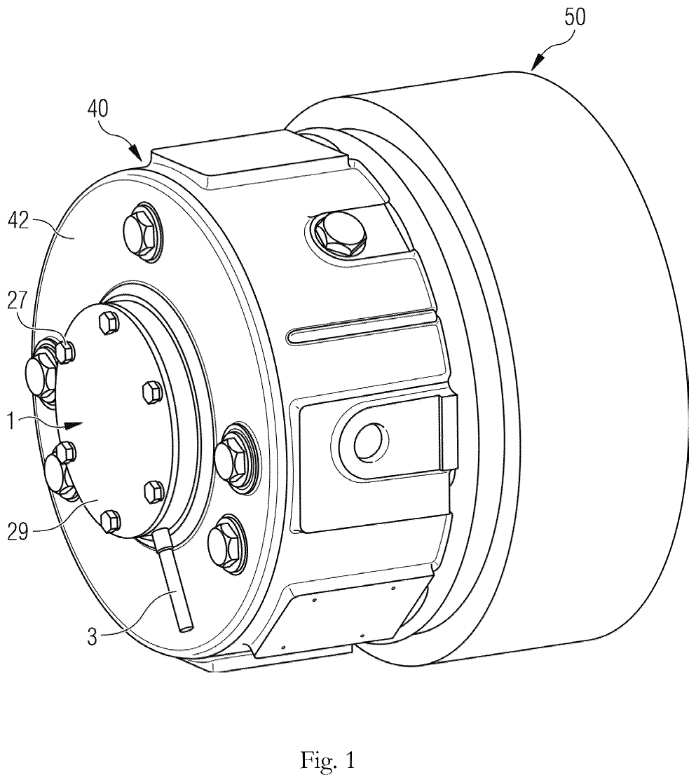

General explanations of the examples follow initially before a detailed description of the example with reference to FIG. 1.

The tachometer assembly according to the invention permits a design which is particularly compact and simple to mount and which can be arranged substantially or entirely inside the outer contour of the motor-mounted brake. Thus practically no additional installation space is required and there is also no risk that the tachometer assembly is damaged during operation (hitting, shearing off, etc.). Due to the compact flat design, the tachometer assembly can also be easily replaced or retrofitted on existing motor-mounted brakes.

There is an example in which the rotor component can be coupled to the motor shaft via a driver which protrudes from the tachometer assembly through a driver opening which is configured in the base flange and, when the tachometer assembly is arranged on the housing component, extends into an interior of the housing component and can be coupled therein to the motor-mounted brake. In such an example, all of the components which are required for operating the tachometer assembly, or are required for connecting the tachometer assembly to the motor-mounted brake, are arranged so as to be optimally protected in the housing component of the motor-mounted brake itself.

There are examples in which the cover and the stator component can be coupled to the housing component by common fastening elements. In this manner, existing connecting bores (threaded bores in the housing component) can be used in order to couple both the tachometer assembly itself via the stator component to the housing component of the motor-mounted brake, and also at the same time to shield the entire tachometer assembly or the interior thereof relative to the outside environment by means of the fixable cover.

There are examples in which sealing assemblies between the stator component and cover and between the stator component and housing component close off from the outside environment both the receiving space and the interior of the housing component, in which the actual motor-mounted brake is arranged, in a fluid-tight manner. Thus both the tachometer assembly itself and the essential elements of the motor-mounted brake are reliably sealed relative to environmental influences.

There are examples in which the cover is formed of an electrically insulating material so that the essential tachometer components can also be effectively shielded from outside relative to electrical influences.

There are examples in which the rotor component can be coupled to the driver via an element protruding into the receiving space. Thus it is possible by a suitable design of this driver to adapt a tachometer assembly to different constructions and sizes of the motor-mounted brake. An adaptation of the elements of the actual motor-mounted brake is not required.

There are examples in which the tachometer assembly serves as an electronic monitoring device which outputs a signal which corresponds to an operating criterion. Thus it is not only possible to detect and monitor the actual speed but it is also possible, for example, to draw conclusions about a maintenance status of the drive assembly and/or the motor-mounted brake, for example via speed changes in specific operating states. For example, signs of wear on the brake disks or brake pads or abnormal operating properties of the drive can thus be monitored and determined.

There are examples in which the receiving space is embedded entirely inside the housing component. In such an example, the tachometer assembly disappears entirely inside the contour of the housing component of the motor-mounted brake. No additional installation space is required.

A further aspect of the invention relates to a motor-mounted brake having a housing component which is configured for receiving a tachometer assembly according to the invention.

There are examples in which the housing component of the motor-mounted brake is provided with a connecting opening corresponding to the centering collar of the stator component. Thus the tachometer assembly can be particularly easily centered in the housing component and thus also arranged and fixed to the concentrically acting, movable elements of the motor-mounted brake.

A further aspect relates to a drive assembly having a motor-mounted brake according to the invention and a drive unit coupled to the motor-mounted brake, for example an electrical drive unit or an electric motor.

Returning to FIG. 1, this illustrates an example of a tachometer assembly 1 or a motor-mounted brake 40 or a drive assembly 50 corresponding to the present invention.

A drive assembly 50 stylized by a cylinder is provided with a motor-mounted brake 40. The motor-mounted brake comprises a housing component 42 which carries on its front face a tachometer assembly 1 according to the invention. Signals of the tachometer assembly can be transmitted via a supply line 3, for example, to a control unit.

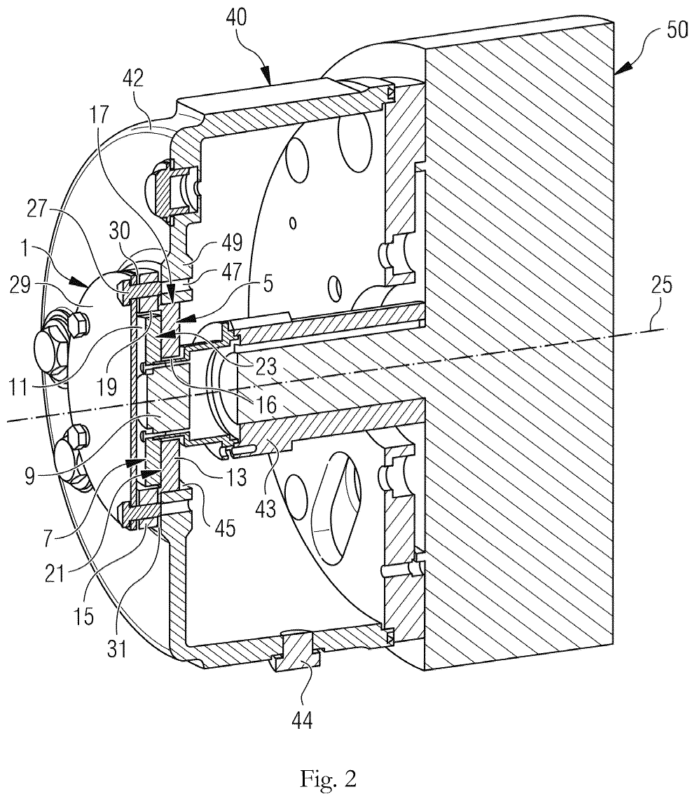

The further construction and function of the tachometer assembly 1 are found in FIG. 2. The tachometer assembly 1 comprises a stator component 5, a movable rotor component 7 which is coupled fixedly in terms of rotation to a hub 43 of the motor-mounted brake 40 via a driver 9. Wherein the hub 43 in turn is coupled fixedly in terms of rotation to a drive shaft 51 of the drive assembly 50.

The stator component 5 comprises a stator body 11 which has a base flange 13 and a connecting flange 15. The outer circumference of the base flange 13 is configured as a cylindrical centering collar 17. The connecting flange 15 which protrudes radially outwardly beyond the centering collar 17 is adjoined thereto in an axially offset manner.

A cylindrical inner wall 19, together with an outer surface 21 of the base flange 13, forms a (cylindrical) receiving space 23 in which the rotor component 7 is arranged. The centering collar 17 is arranged coaxially to a central axis of rotation 25 in a corresponding connecting opening 45 of the housing component 42 in a centered manner and thus also centered to the hub 43 or the drive shaft 101 which also run coaxially to the central axis of rotation 25.

By corresponding threaded bores 47 in the housing component 42, the stator body 11 is connected thereto via fastening elements 27. The fastening elements 27 are configured here as screws. The fastening elements 27 also encompass a cover 29 which closes the receiving space 23 toward the outside.

Seals 30 or 31 are provided for the reliable sealing between the cover 29 and the connecting flange 15, on the one hand, and between the connecting flange 15 and the fastening region 49 surrounding the connecting opening 45. The receiving space 23 and the housing component 42 are thus reliably closed off from the environment.

Additionally, the housing component 42 can be provided with closable maintenance and adjustment openings 44. The driver 9 is coupled to the hub 43 on its brake side end and passes through a through-opening 16 in the base flange 13 and protrudes into the receiving space 23 where the rotor component 7 is connected to the driver.

In this manner, all of the rotational movements of the motor-mounted brake 40 or the drive assembly 50 are transferred via the driver 9 to the rotor component 7, which moves relative to the stator component 5. This rotation is detected both regarding the direction and the speed via suitable electronic, optical or mechanical components and converted into a transmittable signal which can be transmitted via the supply line 3 to a controller. The controller can detect or identify operating criteria of the drive or the motor-mounted brake.

In an example, the fastening region 49 may be configured to be countersunk axially into the housing component 42, so that a further receiving space which can receive the tachometer assembly 1 entirely within the contour of the housing component 42 is configured therein. In this manner, the tachometer assembly “disappears” entirely inside the housing component.

The invention relates to a tachometer assembly (1) for a motor-mounted brake (40) comprising: a stator component (5) which, in operation, can be coupled to a housing component (42) of the motor-mounted brake (40), a rotor component (7), which can be coupled to a drive shaft (51) passing through the motor-mounted brake (40), wherein the stator component (5) comprises a stator body (11) which has a base flange (13) and a connecting flange (15), the base flange (13) has a housing-side centering collar (17) on its outer circumference, the connecting flange (15) adjoins the base flange (13) in an axially offset manner and forms an inner wall (19) on its inner circumference, which together with an outer surface (21) of the base flange (13) forms a receiving space (23) for the rotor component (7), and the receiving space (23) is closed off from the outside environment by a cover (29) which can be fixed to the connecting flange (15).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A tachometer assembly for a motor-mounted brake, the assembly comprising:
a stator component, which, in operation, is adapted to be coupled to a housing component of the motor-mounted brake; and
a rotor component adapted to be coupled to a drive shaft passing through the motor-mounted brake,
wherein the stator component comprises a stator body that has a base flange and a connecting flange, the base flange having a housing-side centering collar on an outer circumference,
wherein the connecting flange adjoins the base flange in an axially offset manner and forms an inner wall on its inner circumference, which together with an outer surface of the base flange forms a receiving space for the rotor component, and
wherein the receiving space is closed off from an outside environment by a cover that is adapted to be fixed to the connecting flange.

2. The tachometer assembly as claimed in claim 1, wherein the rotor component is adapted to be coupled to the drive shaft via a driver that protrudes from the tachometer assembly through a through-opening that is configured in the base flange and, when the tachometer assembly is arranged on the housing component, extends into an interior of the housing component and is adapted to be coupled therein to the motor-mounted brake.

3. The tachometer assembly as claimed in claim 1, wherein the cover and the stator component are coupled to the housing component by fasteners.

4. The tachometer assembly as claimed in claim 1, wherein a sealing assembly arranged between the stator component and cover closes off the receiving space in a fluid-tight manner, and wherein, between the stator component and housing component, the sealing assembly closes off an interior of the housing component in a fluid-tight manner.

5. The tachometer assembly as claimed in claim 1, wherein the cover is formed of an electrically insulating material.

6. The tachometer assembly as claimed in claim 1, wherein the rotor component is adapted to be coupled to the driver via an element protruding into the receiving space.

7. The tachometer assembly as claimed in claim 1, wherein the tachometer assembly serves as an electronic monitoring device that outputs a signal which corresponds to an operating criterion of the motor-mounted brake and or the drive assembly.

8. The tachometer assembly as claimed in claim 1, wherein the receiving space is embedded entirely inside the housing component.

9. A motor-mounted brake comprising a housing component configured to receive a tachometer assembly as claimed in claim 1.

10. The motor-mounted brake as claimed in claim 9, further comprising a connecting opening corresponding to the centering collar.

11. The motor-mounted brake as claimed in claim 9, further comprising a fastening region that is countersunk inwardly inside the housing component.

12. A drive assembly comprising:
a motor-mounted brake as claimed in claim 9; and
a drive unit coupled to the motor-mounted brake.
